(19) United States
(12) Patent Application Publication
(10) Pub. No.: US 2005/0264162 A1
(43) Pub. Date: Dec. 1, 2005

(54) Blue phosphor for plasma display panel and method of preparing the same

(76) Inventors: Kyu-Chan Park, Suwon-si (KR); Seon-Young Kwon, Suwon-si (KR); Yong-Seon Kim, Suwon-si (KR); Ick-Kyu Choi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/139,087

(22) Filed: May 27, 2005

(30) Foreign Application Priority Data
May 28, 2004 (KR) 10-2004-0038258

(51) Int. Cl. H01J 11/02; H01J 17/49

(52) U.S. Cl. 313/486

(57) ABSTRACT

A blue phosphor can be used for a plasma display panel. The blue phosphor is formed with a core phosphor and a europium coating layer over the core phosphor. The core phosphor is expressed by the following formula 1:
(Ba₁₋ₓEuₓ)O.Mg_{y}O(Al₂O₃)_{z} (1)
In the formula, 0.005≦x≦0.05, 1≦y≦2, and 5≦z≦7. The europium coating layer includes europium divalent ions, Eu²⁺. In a method of making the blue phosphor, the core phosphor is mixed with a europium containing compound such as Eu₂O₃, and the mixture is thermally treated to form the europium coating layer.

### CROSS REFERENCE TO RELATED APPLICATION

This application claims priority to and the benefit of Korean patent application No. 10-2004-0038258 filed in the Korean Intellectual Property Office on May 28, 2004, the entire disclosure of which is incorporated herein by reference.

### BACKGROUND

1. Field of the Invention

The present invention relates to a blue phosphor for a plasma display panel and a method of preparing the same, and more particularly to a blue phosphor for a plasma display panel having a good life span and a method of preparing the same.

2. Description of Related Technology

Generally, a plasma display panel (hereinafter referred to as a “PDP”) is a display which realizes an image through excitation of phosphor using ultraviolet rays generated from a gas discharge. It can realize a large screen with high resolution and is currently in the spotlight as a next generation thin display device.

A PDP device includes a plurality of barrier ribs that are disposed with a certain separation to form a discharge cell between a front substrate and a rear substrate. In the discharge cell, red, green, and blue phosphor layers are formed. Typically on the rear substrate, address electrodes to which the address signal is applied are formed. On the front substrate, a pair of display electrodes is formed, with a certain separation, in one discharge cell in a perpendicular direction to that of the address electrodes.

In the foregoing configuration, three electrodes are provided in each discharge cell of the PDP device. A surface of each discharge cell is coated with one of the red, green, and blue phosphors. In the discharge cell, a discharge gas such as Ne—Xe or He—Xe is filed. When a certain level of voltage is applied between these electrodes, plasma discharge occurs to generate vacuum ultraviolet radiation from Xe ions. The ultraviolet radiation excites the phosphors to emit visible light.

Phosphors for PDP devices have been researched to improve luminance, light-emitting efficiency, color purity, and afterglow time. PDP phosphors should be stable when subject to heat or ultraviolet radiation. Up to the present, Ba-based BaMgAl₁₀O₁₇:Eu²⁺ has been primarily used as a blue PDP phosphor. However, this phosphor is not stable in certain manufacturing conditions and color purity may be deteriorated.

More specifically, Eu²⁺ in the Ba-based phosphor is not stable and is often oxidized to Eu³⁺. As a result, the wavelength of emitted light moves to a longer wavelength, by which color purity is decreased, and consequently, the life span of the PDP device is decreased.

U.S. Pat. No. 6,187,225 discloses a composition including (La_{1-x-y-}zTmxLiyAEz)PO₄ (wherein, AE is a alkaline rare earth metal, 0.001≦x≦0.05, 0.01≦y≦0.05, 0≦z≦0.05), which is mixed or coated with a Ba-based phosphor.

Korean Patent Laid-open No. 2003-14919 discloses a Ba-based phosphor including a spinal layer and a conductive layer. The conductive layer of the Ba-based phosphor is selectively coated with a material such as Ba, B, Mg and P.

U.S. Pat. No. 5,811,154 discloses a method of coating a Ba-based phosphor with Al₂O₃ or Y₂O₃.

Japanese Patent Laid-open Publication No. 2001-303037 discloses a method of coating a surface of the blue phosphor with amorphous SiO₂ film.

### SUMMARY OF CERTAIN INVENTIVE ASPECTS

One aspect of the invention provides a blue phosphor, which comprises a core phosphor and a coating layer formed over the core phosphor. The coating layer comprises europium, at least part of which exists in the divalent ion form, Eu²⁺. The core phosphor may comprise a compound represented by the following formula 1: (Ba₁₋ₓEuₓ)O.Mg_{y}O(Al₂O₃)_{z}, wherein 0.005≦x≦0.05, 1≦y≦2, and 5≦z≦7. The core phosphor may further comprise divalent europium ions, Eu²⁺. The coating layer may comprise europium in an amount from about 0.005 mol % to about 0.05 mol % relative to the total amount of the core phosphor and the coating layer. The coating layer has a thickness from about 1 nm to about 50 nm. The core phosphor may comprise europium, which has a concentration gradient in the core phosphor. Europium may have a higher concentration toward outside of the core phosphor than toward the inside of the core phosphor.

Another aspect the invention provides a method of preparing a blue phosphor, which comprises a core phosphor and a europium coating layer formed over the core phosphor. The method comprises providing a core phosphor; mixing a europium containing compound with the core phosphor; and firing the resulting mixture at a temperature sufficient to form the europium layer over the core phosphor. The core phosphor may comprise a compound represented by the formula 1 as set for the above. The europium containing compound may be selected from the group consisting of Eu₂O₃, EuCl₃, EuF₃, and Eu(NO₃)₃. The temperature may be from about 500° C. to about 1200° C. The firing may continue for about 1 hour to about 5 hours. During the firing, europium may migrate into the core phosphor. The firing may be performed under a reducing gas atmosphere. The reducing gas atmosphere may comprise hydrogen and nitrogen. The volume ratio of hydrogen to nitrogen may be about 1:99 to about 1:9.

Another aspect of the invention provides a plasma display panel device, which comprises a blue light discharge cell; a blue phosphor placed in the blue light discharge cell and configured to emit blue light upon exposure to ultraviolet radiation. The blue phosphor comprises a core phosphor and an activator layer coated over the core phosphor. The activator layer may comprise divalent europium ions. The core phosphor may comprise a compound represented by the formula 1 as set forth above. The activator layer may comprise a portion substantially free of Ba. The core phosphor may further comprise europium.

A further aspect of the invention provides a method of generating blue light. The method comprises radiating ultraviolet rays to a blue phosphor, which comprises a core phosphor and a europium coating over the core phosphor. The ultraviolet rays reach the core phosphor through the europium coating layer. The method further comprises emitting blue light from the core phosphor, in which the blue light passes through the europium coating layer. The coating layer has a thickness from about 1 nm to about 50 nm.

### BRIEF DESCRIPTION OF THE DRAWING

The accompanying drawing, which is incorporated in and constitutes a part of the specification, illustrates one embodiment of the invention, and together with the description, serves to explain the principles of the invention, wherein:

FIG. 1 is a schematic perspective view showing the structure of a plasma display panel.

### DETAILED DESCRIPTION OF CERTAIN INVENTIVE EMBODIMENTS

In the following detailed description, certain inventive embodiments of the invention are described. The drawings and description are to be regarded as illustrative in nature, and not restrictive.

In one embodiment of the invention, blue phosphor is coated with a layer containing europium to form coated phosphor particles. The blue phosphor forms a core portion coated with the europium coating layer. The europium layer covers all or at least a substantial portion of the core phosphor.

In one embodiment, the blue phosphor is a Ba-based phosphor represented by the following formula 1:
(Ba₁₋ₓEuₓ)O.Mg_{y}O(Al₂O₃)_{z} (1)
0.005≦x≦0.05, 1≦y≦2, and 5≦z≦7.

The Ba-based blue phosphor of formula 1 is a phosphor having a blue light-emitting band, for example a 450 nm band, when it is excited with ultraviolet radiation of, for example, 147 nm and 172 nm, emitted from the plasma of Xe gas. In other embodiments, other blue light-emitting phosphors may be coated with a europium coating layer. In such embodiments, the blue light-emitting phosphor is chosen from those that can be activated by divalent europium ions, Eu²⁺. For example, such blue light-emitting phosphors include (Ba₁₋ₓEuₓ)O.Mg_{y}O(Al_{2-y}MᵥO₃)_{z}, in which M is at least one selected from the group consisting of La, Y, Gd, and Ga. In the foregoing formula, 0.005≦x≦0.05, 1≦y≦2, 5≦z≦7, and 0.1≦v≦1.

In one embodiment, the europium coating layer contains an activator of Eu²⁺. The europium coating layer is formed with one or more forms of the europium attached to the core phosphor. In one embodiment, the europium of the europium coating layer contains europium in its divalent ion form, Eu²⁺. In an embodiment, the europium coating layer contains europium in the form of oxide, such as Eu₂O₃, although not limited thereto. In various embodiments, the coating layer may contain elements other than europium, which include, for example, elements that are contained in the precursor compound for the europium coating layer or elements that are contained in the core phosphor.

In one embodiment, the europium coating layer is formed in a thickness that does not deteriorate the light-emitting efficiency of the europium coated phosphor. For example, the europium coating layer should allow ultraviolet light to reach the core phosphor, and should allow visible light emitted from the core phosphor to pass therethrough. The thickness of the europium layer is, for example, from about 1 nm to about 50 mm. In one embodiment, the europium coating layer contains europium from about 0.0005 mol % to about 0.05 mol % relative to the total amount of the core phosphor and the europium coating layer.

A small amount of europium may be doped into the core phosphor. In one embodiment of making the europium coated phosphor, as will be further discussed below, a precursor compound of the europium coating layer is coated over the surface of the core phosphor particles, which is then subject to firing at a high temperature. During the firing or any other high temperature processes, some of the europium precursor compound may be melted into the core phosphor. However, most of europium remains in the europium coating layer. In an embodiment, there is a gradient of the europium concentration in a given phosphor particle with the europium coating layer. For example, the outermost shell of the phosphor particle forms the europium coating layer, in which the europium concentration is the highest. The interior of the europium coating layer is the core phosphor. An outer portion of the core phosphor has a higher europium concentration than an inner portion of the core phosphor.

Further in one embodiment, a small amount of metallic components of the core phosphor may migrate from the core phosphor to the europium coating layer during the high temperature firing. In another embodiment, at least a portion of the europium coating layer is substantially free of the other metallic components of the core phosphor. In the foregoing embodiment, the at least one portion is an outermost portion of the europium coating layer.

As will be discussed, the europium coated blue light-emitting phosphors according to the embodiments show greater stability and maintain color purity over counterpart phosphors without the europium coating layer.

Turning to embodiments for making the europium coated phosphor, a blue light-emitting phosphor is mixed with a precursor compound of the europium coating layer. As discussed above, the core phosphor is a Ba-based phosphor and/or other blue light-emitting phosphors. The precursor compound of the europium coating layer is chosen from europium containing compounds including, not limited to, Eu₂O₃, EuCl₃, EuF₃, and Eu(NO₃)₃. In the mixture, the precursor compound contact surfaces of the core phosphor particles. Then, the mixture of the precursor compound and the core phosphor is subjected to firing, in which europium divalent ions are attached onto the surface of the core phosphor particles and form the europium coating layer. During the firing process, the precursor compound may or may not undergo a chemical reaction and turn to a different form while resulting in some divalent europium ions entangling with the core phosphor to form the europium coating layer.

In one embodiment, the precursor compound is mixed with the core phosphor in an amount such that the europium coating layer contains Eu²⁺ from about 0.005 mol % to about 0.05 mol % relative to the total amount of the core phosphor and the europium coating layer. In one embodiment where the core phosphor contains europium as in formula 1, the amount of the europium-containing precursor compound is from about 5% to about 50% by weight relative to the total weight of europium compound used for preparing the compound of formula 1.

The core phosphor can be prepared by any known method for making a blue phosphor. To make a Ba-based blue phosphor of the formula 1, for example, a magnesium compound, an aluminum compound, a barium compound, and a europium compound are mixed together, and the resultant mixture is heat-treated at about 15000 for about 10 hours. Then this heat-treated product is fired under a reducing atmosphere at about 14000 for about 3 hours. As for the magnesium compound, magnesium oxide such as MgO can be used; as for the aluminum compound, aluminum oxide such as Al₂O₃ can be used; as for the barium compound, barium oxide such as BaCO₃ can be used; and as for the europium compound europium oxide such as Eu₂O₃ can be used. For the reducing atmosphere, for example, a mixture of nitrogen and hydrogen gases in a volume ratio of about 97:3 can be used.

The thickness of the europium coating layer may be controlled by adjusting the amount of the europium precursor compound. Generally, the more europium in the europium coating layer, the greater the thickness of the europium coating layer. The thickness of the europium coating layer may also be controlled by adjusting the temperature for firing process. Generally, if the firing temperature is too high, all or a significant portion of the europium ions may migrate into the core phosphor. On the other hand, if the firing temperature is too low, europium ions may not be attached to the surface of the core phosphor particles. In either case, a europium coating layer may not be formed outside the core phosphor.

In one embodiment, the firing of the core phosphor coated with the precursor compound is performed at about 500° C. to about 1200° C. In one embodiment, the firing may be continued from about 1 hour to about 5 hours. In one embodiment, the firing process is performed under a reducing gas atmosphere. More specifically, a mixture of hydrogen and nitrogen gas provides the reducing gas atmosphere. In one embodiment, the ratio of the hydrogen to nitrogen is from 1:99 by volume to 10:90 by volume. This reducing gas atmosphere is to maintain the europium ions in the divalent form while not excessively reducing other metallic cations existing the core phosphor.

Through the firing process, the europium precursor compound is converted to Eu²⁺, which surrounds and is attached to the surface of the core phosphor particles. As a result, the europium coating layer is formed covering the core phosphor. As discussed above, during the firing process, some of the europium ions may migrate into the core phosphor, and therefore a concentration gradient of the europium may be formed generally in a radical direction of the particles.

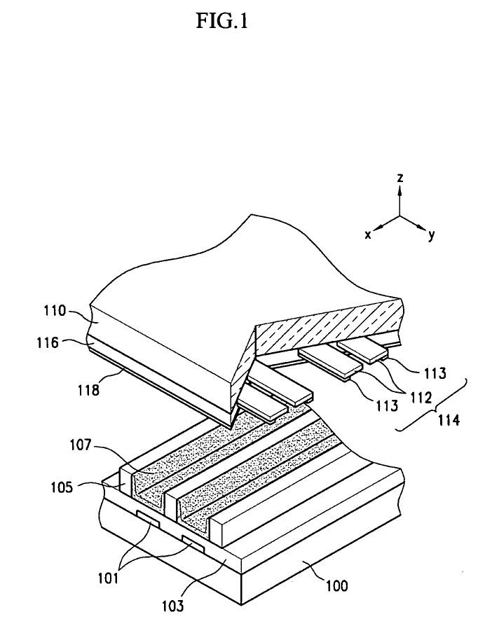

In one embodiment, the phosphor with the europium coating layer may be used for the blue phosphor of a PDP device. FIG. 1 illustrates an exemplary structure of a PDP device. Referring to FIG. 1, address electrodes 101 are formed on a rear substrate 100 along one direction (the X-axis of the drawing) and a dielectric layer 103 is formed on the entire surface of the rear substrate 100 covering the address electrodes 101. Stripe patterned barrier ribs 105 are formed to be positioned between the respective address electrodes 101 on the dielectric layer 103. Red (R), green (G), and blue (B) phosphor layers 107 are formed between the barrier ribs 105.

On the one side of a front substrate 110 facing a rear substrate 100, display electrodes 114, including a pair of a transparent electrode 112 and a bus electrode 113, following the perpendicular direction (Y-axis) are formed. A dielectric layer 116 and a MgO protective layer 118 are formed covering the entire surface of display electrodes 114. The address electrodes 101 on the rear substrate 100 and the display electrodes 114 on the rear substrate 110 are crossed to form a discharge cell.

When an address voltage (Va) is applied between the address electrodes 101 and display electrodes 114, an address discharge occurs, and then a sustain discharge occurs by a sustain voltage being applied between a pair of display electrodes 114. The vacuum ultraviolet rays are generated during the sustain discharge and excite the phosphor contained in the discharge cells. Visible light is emitted from the phosphor through the front substrate 110 to realize an image display on the PDP device. In the foregoing embodiments, the blue light-emitting phosphor with the europium coating layer generates blue light.

The following examples illustrate the present invention in further detail. However, it is to be understood that the present invention is not limited by these examples.

### EXAMPLE 1

MgO 29.7 g, Al₂O₃ 375.7 g, Eu₂O₃ 6.5 g and BaCO₃ 138.2 g were mixed. The mixture was heat-treated at about 1500□ for about 10 hours and then was cooled to room temperature. The cooled product was subject to a first firing in a reducing atmosphere, which contained 3 volume % of hydrogen and 97 volume % of nitrogen, at about 1400 □ for about 3 hours. Subsequently, the first fired product was mixed with glass ball and distilled water in the weight ratio of 1:3:2, followed by milling at 100 rpm for about 3 hours and drying, which resulted in a powder core phosphor of Ba_{0.95}MgAl₁₀O₁₇:Eu²⁺_{(0.05)} with about 5 μm diameter.

To the core phosphor, Eu₂O₃ was added and mixed. The mixture was subject to a secondary firing at about 800□ in a 5% hydrogen atmosphere to provide the phosphor with the europium coating layer. The added amount of Eu₂O₃ is 10% by weight relative to the amount of Eu₂O₃ used in preparing the core phosphor, which was 0.65 g.

### EXAMPLE 2

The same procedure as in Example 1 was performed, except that the secondary firing was performed at about 1000 μl in a 5% hydrogen atmosphere.

### EXAMPLE 3

The same procedure as in Example 1 was performed, except that Eu₂O₃ added to the core phosphor was 1.3 g, which is 20% by weight relative to the amount of Eu₂O₃ used in preparing the core phosphor.

### EXAMPLE 4

The same procedure as in Example 3 was performed, except that the secondary firing was performed at about 10000 in a 5% hydrogen atmosphere.

### COMPARATIVE EXAMPLE

The powder Ba_{0.95}MgAl₁₀O₁₇:Eu²⁺_{(0.05)} core phosphor without a europium coating layer prepared in Example 1 was used as a blue phosphor in the following example, Example 5.

### EXAMPLE 5

The phosphors of the Examples 1 to 4 and the Comparative Example were heat-treated (fired) at 500 □ for 1 hour. y color coordinates (CIEy) and brightness of the phosphors of Examples 1-4 and Comparative Example were measured before and after the heat treatment. The results are shown in Table 1.

TABLE 1

| | Eu₂O₃ for | | | | | | |
|---|---|---|---|---|---|---|---|
| | europium | | | | | | |
| | coating layer | | | | | | |
| | relative to the | CIEy | | | Brightness | | |
| | EuO₃ amount in | Before | After | | Before | After | Secondary |
| | the core | heating | heating | Difference | heating | heating | firing |
| | phosphor | process | process | value | process | process | temperature |
| Comp. Ex. | — | 0.0539 | 0.0647 | 0.0108 | 100% | 100% | — |
| Ex. 1 | 10 wt % | 0.0662 | 0.0673 | 0.0011 | 98.8% | 98.8% | 800□ |
| Ex. 2 | 10 wt % | 0.0643 | 0.0696 | 0.0053 | 98.8% | 101% | 1000□ |
| Ex. 3 | 20 wt % | 0.0616 | 0.0701 | 0.0085 | 93.3% | 100% | 800□ |
| Ex. 4 | 20 wt % | 0.0669 | 0.0741 | 0.0072 | 103% | 112% | 1000□ |

As shown in Table 1, the phosphors of Examples 1 to 4 have smaller value changes than the phosphor of Comparative Example in y color coordinates between before and after heating. More specifically, the value changes of the phosphors of Examples 1-4 after the heating in y color coordinates were about 10 to about 70% of the value change of the phosphor of Comparative Example. This result represents that the phosphors of Examples 1-4 having the europium coating layer are less susceptible to high temperature than the phosphor of Comparative Examiner without a europium coating layer. Further, the phosphors of Examples 1-4 maintain higher color purity than Comparative Example over extended exposure to high temperature. Also, brightness of the phosphors of Examples 1 to 4 is similar or higher compared with that of Comparative Example 1.

The blue phosphor with a europium coating layer can maintain color purity even if it is subjected to high temperature during the fabrication or operation of PDP devices. The PDP devices employing the blue phosphor with the europium coating layer would have a longer life span without compromising brightness than those using the blue phosphor without a europium coating layer.

While the present invention has been described in detail with reference to certain embodiments, those skilled in the art will appreciate that various modifications and substitutions can be made thereto without departing from the spirit and scope of the present invention as set forth in the appended claims.

1. A blue phosphor, comprising:
a blue light-emitting core phosphor; and
a coating layer comprising europium and formed over the core phosphor, wherein at least part of the europium exists in the divalent ion form, Eu²⁺.

2. The blue phosphor of claim 1, wherein the core phosphor comprises a compound represented by the following formula 1:
(Ba₁₋ₓEuₓ)O.Mg_{y}O(Al₂O₃)_{z} (1),
wherein 0.005≦x≦0.05, 1≦y≦2, and 5≦z≦7.

3. The blue phosphor of claim 1, wherein the core phosphor comprises divalent europium ions, Eu²⁺.

4. The blue phosphor of claim 1, wherein the coating layer comprises europium in an amount from about 0.005 mol % to about 0.05 mol % relative to the total amount of the core phosphor and the coating layer.

5. The blue phosphor of claim 1, wherein the coating layer has a thickness from about 1 nm to about 50 nm.

6. The blue phosphor of claim 1, wherein the core phosphor comprises europium, and wherein europium in the core phosphor has a concentration gradient.

7. The blue phosphor of claim 6, wherein europium has a higher concentration toward outside of the core phosphor than toward the inside of the core phosphor.

8. A plasma display panel device, comprising:
a blue light discharge cell;
a blue phosphor placed in the blue light discharge cell and configured to emit blue light upon exposure to ultraviolet radiation; and
wherein the blue phosphor comprises a core phosphor and an activator layer coated over the core phosphor.

9. The device of claim 8, wherein the activator layer comprises divalent europium ions.

10. The device of claim 8, wherein the core phosphor comprises a compound represented by the following formula 1:
(Ba₁₋ₓEuₓ)O.Mg_{y}O(Al₂O₃)_{z} (1),
wherein 0.005≦x≦0.05, 1≦y≦2, and 5≦z≦7.

11. The device of claim 10, wherein the activator layer comprises a portion substantially free of Ba.

12. The device of claim 8, wherein the core phosphor further comprises europium.

13. A method of preparing the blue phosphor, the method comprising:
providing a core phosphor;
mixing a europium containing compound with the core phosphor; and
firing the resulting mixture at a temperature sufficient to form the coating layer over the core phosphor.

14. The method of claim 13, wherein the core phosphor comprises a compound represented by the following formula 1:
(Ba₁₋ₓEuₓ)O.Mg_{y}O(Al₂O₃)_{z} (1),
wherein 0.005≦x≦0.05, 1≦y≦2, and 5≦z≦7.

15. The method of claim 13, wherein the europium containing compound is selected from the group consisting of Eu₂O₃, EuCl₃, EuF₃, and Eu(NO₃)₃.

16. The method of claim 13, wherein the temperature is from about 500° C. to about 1200° C.

17. The method of claim 13, wherein the firing continues for about 1 hour to about 5 hours.

18. The method of claim 13, wherein during the firing europium migrates into the core phosphor.

19. The method of claim 13, wherein the firing is performed under a reducing gas atmosphere.

20. The method of claim 19, wherein the reducing gas atmosphere comprises hydrogen and nitrogen.

21. The method of claim 19, wherein a volume ratio of hydrogen to nitrogen is about 1:99 to about 1:9.

22. A blue phosphor produced by the method of claim 13.
